(19) United States
(12) Patent Application Publication
(10) Pub. No.: US 2005/0225646 A1
(43) Pub. Date: Oct. 13, 2005

(54) Camera incorporating a lens barrel

(75) Inventor: Dai Shintani, Osaka (JP)

Correspondence Address: BRINKS HOFER GILSON & LIONE, P.O. BOX 10395, CHICAGO, IL, 60610, US

(73) Assignee: Konica Minolta Photo Imaging, Inc.

(21) Appl. No.: 11/100,793

(22) Filed: Apr. 7, 2005

(30) Foreign Application Priority Data
Apr. 12, 2004 (JP) 2004-116485
Oct. 21, 2004 (JP) 2004-306449

(51) Int. Cl. H04N 5/228

(52) U.S. Cl. 348/208.99

(57) ABSTRACT

A lens barrel constituting a taking lens system is incorporated in the camera body, and the lens barrel is swingably supported by a first rotation shaft and a second rotation shaft. A shake applied to the camera body is detected by a shake detector, and a correction movement amount for moving the lens barrel by a predetermined amount for shake prevention is calculated based on the detection signal. The lens barrel is driven for shake prevention by an actuator in accordance with the obtained correction movement amount.

This application is based on the application No. 2004-116485 and No. 2004-306449 filed in Japan, the contents of which are hereby incorporated by reference.

### BACKGROUND OF THE INVENTION

1. Field of the Invention

The present invention relates to a camera incorporating a lens barrel, provided with a mechanism for preventing image blurring due to a camera shake at the time of shooting in digital cameras and the like.

2. Description of the Related Art

In digital still cameras and the like, various kinds of camera shake prevention mechanisms (camera shake compensation mechanisms) are adopted to preventing blurring of shot images due to the user's hand shake or the like. An example of recently adopted typical methods is to drive a lens unit disposed in the lens barrel within a plane vertical to the optical axis in a direction that cancels the shake applied to the camera. Another example is to drive a solid-state image sensor, such as a CCD, itself within a plane vertical to the optical axis without driving a lens unit in the lens barrel.

On the other hand, U.S. Pat. No. 4,788,596 discloses a method in which in a camera where the lens barrel protrudes from the camera body, blurring of shot images is prevented by supporting the lens barrel itself so as to be rotatable with respect to the camera body and when a camera shake or the like is detected, rotating the lens barrel in a direction that cancels the shake.

However, according to the method in which a lens unit disposed in the lens barrel is driven for shake prevention, it is necessary to design optical performance sensitivities such as parallel decentering and inclined decentering of the lens unit so as to be minimized. Consequently, the degree of freedom in optical design is lost, so that the lens barrel size is increased and sufficient shake prevention performance cannot be easily obtained. In addition, when a lens improvement or the like is made, it is necessary to re-design the lens unit. On the other hand, according to the method in which the solid-state image sensor itself is driven for shake prevention, the driving result (for example, an inclination of the solid-state image sensor) directly affects the shooting performance. Consequently, it is necessary to drive the solid-state image sensor for shake prevention with extremely high accuracy, and it is required that the actuator serving as the driving source have higher performance. Further, it is necessary to construct an optical system having an image circle that covers the moving range of the solid-state image sensor so that an image is always supplied from the lens barrel in accordance with the movement of the solid-state image sensor, and this inevitably increases the complexity and size of the mechanism.

In the camera described in U.S. Pat. No. 4,788,596 where the lens barrel protrudes from the camera body, even if a mechanism that rotates the lens barrel itself so as to cancel the camera shake is provided, since the lens barrel is exposed to the outside, the user can touch the lens barrel. When the user is touching the lens barrel, the shake prevention driving is substantially not performed. Moreover, in cameras of a type that attains zooming and the like by changing the lens barrel length (the length of the protrusion from the body), since the center of gravity of the lens barrel shifts due to zooming, the load on the actuator is not quantitative, so that it is difficult to optimize the shake prevention driving mechanism.

Accordingly, an object of the present invention is to provide a camera having a shake prevention mechanism, capable of using an existing lens barrel as it is without applying any design load on the optical system.

### SUMMARY OF THE INVENTION

To attain the above-mentioned object, a camera incorporating a lens barrel according to the present invention comprises: a lens barrel having a taking lens system and incorporated in a camera body; a supporter for supporting the lens barrel so as to be swingable; a shake detector for detecting a shake applied to the camera; a calculator for calculating a correction movement amount for moving the lens barrel based on a detection signal from the shake detector; and an actuator for moving the lens barrel in accordance with the correction movement amount obtained by the calculator.

According to the above-described structure, a shake prevention mechanism can be constructed with a simple structure. Moreover, since the lens barrel is incorporated inside the camera body, it can be prevented that the shake prevention mechanism substantially does not work by the user touching the lens barrel.

### BRIEF DESCRIPTION OF THE DRAWINGS

In the following description, like parts are designated by like reference numbers throughout the several drawings.

FIG. 1 is an explanatory view conceptually showing an example of the structure of a lens barrel incorporating camera according to the present invention;

FIGS. 2(a) and 2(b) are a front view and a rear view, respectively, showing the appearance of a small-size digital camera to which the lens barrel incorporating camera according to the present invention is suitably applied;

FIGS. 3(a) and 3(b) are cross-sectional views showing an example of the internal structure of a bent-type lens barrel, FIG. 3(a) showing a condition where lens units are driven to a telephoto operation condition, FIG. 3(b) showing a condition where the lens units are driven to a wide-angle operation condition;

FIG. 4 is a block diagram schematically showing only a relevant part of the structure of a lens barrel incorporating camera according to a first embodiment;

FIG. 5 is a perspective view showing the condition of incorporation of the lens barrel into the camera body;

FIG. 6 is a partially cutaway front view showing the part of the lens barrel, which is a relevant part of the first embodiment, so as to be enlarged;

FIG. 7 is a side view on the arrow B1 in FIG. 6;

FIG. 8 is a side view on the arrow B2 in FIG. 6;

FIG. 9 is a top view on the arrow B3 in FIG. 6;

FIG. 10 is an exploded perspective view of the part of the lens barrel in the first embodiment;

FIGS. 11(a) and 11(b) are views schematically showing the condition of movement of the lens barrel 2 by a pitch-direction motor 3a and a yaw-direction motor 3b in the first embodiment;

FIG. 12 is a partially cutaway front view showing the part of the lens barrel, which is a relevant part of a second embodiment, so as to be enlarged;

FIG. 13 is a side view on the arrow C1 in FIG. 12;

FIG. 14 is a side view on the arrow C2 in FIG. 12;

FIG. 15 is a top view on the arrow C3 in FIG. 12;

FIG. 16 is an exploded perspective view of the part of the lens barrel in the second embodiment;

FIGS. 17(a) and 17(b) are views schematically showing the condition of movement of the lens barrel 2 by a pitch-direction motor 3a and a yaw-direction motor 3b in the second embodiment;

FIG. 18 is a block diagram schematically showing only a relevant part of the structure of a lens barrel incorporating camera according to a third embodiment;

FIG. 19 is a partially cutaway front view showing the part of the lens barrel, which is a relevant part of the third embodiment, so as to be enlarged;

FIG. 20 is a top view on the arrow D3 in FIG. 19; and

FIGS. 21(a) and 21(b) are views schematically showing the condition of movement of the lens barrel 2 by a pitch-direction motor 3a and a yaw-direction motor 3b in the third embodiment;

### DETAILED DESCRIPTION OF THE PREFERRED EMBODIMENT

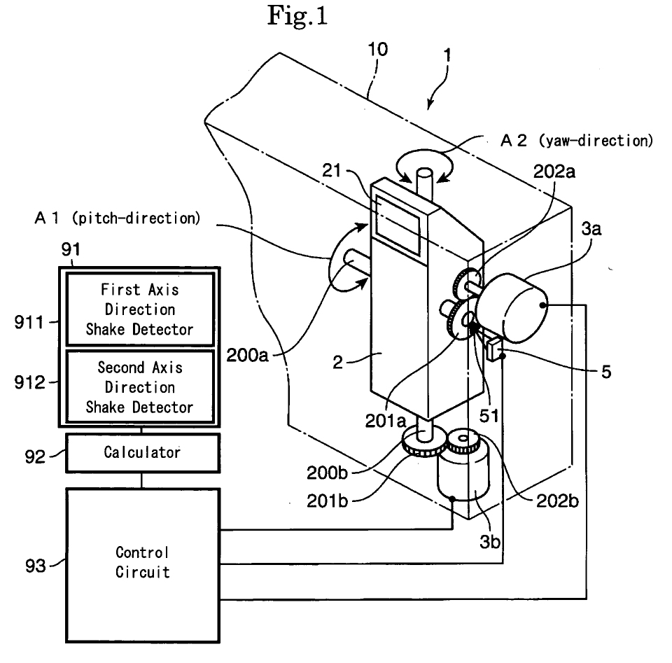

First, an example of the structure of a lens barrel incorporating camera 1 according to the present invention will be briefly described with reference to FIG. 1. The lens barrel (bent-type lens barrel in which the optical axis of the part of the objective lens 21 is bent at a predetermined angle) 2 constituting the taking lens system is incorporated under a condition of being vertically placed inside the camera body 10 (this “vertical placement” means that the optical axis after the bend in the lens barrel 2 is oriented not in the direction of the thickness of the camera 1 but in the direction of, for example, the width or the height of the camera 1 in order to reduce the size, in the direction of the thickness, of the camera 1, and as long as such a requirement is met, the lens barrel 2 itself may be placed either vertically as shown in FIG. 1 or horizontally). This “incorporation” means that part of the lens barrel 2 substantially does not protrude outside from the camera body 10 even when the lens barrel 2 is driven for zooming or focusing for shooting. For this reason, it is desirable that a so-called flat-zoom-type lens system movable in the direction of the optical axis in the lens barrel 2 be used as the lens system housed in the lens barrel 2.

The lens barrel 2 is held by a supporter having a support point that supports the lens barrel 2 so as to be swingable. In the example shown in FIG. 1, the following correspond to the supporter; a first rotation shaft 200a that enables the lens barrel 2 to rotate (swing) in a first direction of the arrow A1 in the figure and a bearing thereof (not shown); and a second rotation shaft 200b that enables the lens barrel 2 to rotate in a second direction of the arrow A2 in the figure and its bearing. It is necessary for the supporter only to swing the lens barrel 2, for example, in two axial directions with the support point as the axis, and the support configuration thereof and the number of support points are not specifically limited. Thus, various support configurations may be adopted such that the lens barrel 2 is swingably supported by use of one or a plurality of ball bearings or the like, that the lens barrel 2 is swingably supported by use of bearings disposed in two axial directions, respectively, and that the lens barrel 2 is supported in a multipoint manner with an elastic member such as a coil spring.

Further, the lens barrel incorporating camera 1 is provided with a shake detector 91 for detecting a shake applied to the camera 1, for example, a shake due to a hand shake. The shake detector 91 is provided with, for example, a first axial direction shake detector 911 comprising a gyro that detects a shake in the rotation direction of the first rotation shaft 200a (the direction of the arrow A1) and a second axial direction shake detector 912 that detects a shake in the rotation direction of the second rotation shaft 200b (the direction of the arrow A2). The detectors 911 and 912 each detect a shake (camera shake) in the detection direction thereof, and transmit the detection signal to a calculator 92. Then, based on the detection signal, the calculator 92 calculates a correction movement amount for moving the lens barrel 2 by a predetermined amount in order to cancel the shake applied to the lens barrel incorporating camera 1.

A signal on the correction movement amount obtained by the calculator 92 is transmitted to a control circuit 93, and the control circuit 93 drives actuators 3a and 3b that move the lens barrel 2 in two axial directions. It is necessary for the actuators 3a and 3b only to move the lens barrel 2, for example, in two axial directions by quickly responding to the shake applied to the camera 1, and as the actuators 3a and 3b, the following may be adopted: actuators comprising a combination of a small-size electric motor and a gear mechanism, a ball screw mechanism or the like disposed in the two axial directions, respectively; actuators using piezoelectric elements; and actuators using a pressure mechanism. In the example shown in FIG. 1, a gear 201a fixed to the first rotation shaft 200a engages with a gear 202a fixed to the rotation shaft of the electric motor as the actuator 3a. With this structure, the lens barrel 2 is rotated in the direction of the arrow A1 about the first rotation shaft 200a inside the camera body 10. Moreover, a gear 201b fixed to the second rotation shaft 200b engages with a gear 202b fixed to the rotation shaft of the electric motor as the actuator 3b. With this structure, the lens barrel 2 is rotated in the direction of the arrow A2 about the second rotation shaft 200b. Since the lens barrel 2 is supported so as to be swingable as described above, it is desirable to provide a position detector 5 for detecting the home position of the lens barrel 2. In the example shown in FIG. 1, a reflector 51 is formed on the gear 201a integrated with the first rotation shaft 200a, and the position detector 5 comprising a light-reflection-type optical sensor is disposed opposite to the reflector 51.

In the lens barrel incorporating camera 1 structured as described above, the support point by the supporter is set in the vicinity of the center in the direction of the lens barrel length. With this structure and the structure that the length of the lens barrel 2 does not vary even during zooming or focusing, the lens barrel 2 is supported substantially at the center of gravity thereof in each axial direction. Consequently, actuators with comparatively low output power can be used as the actuators that move the lens barrel 2. Moreover, the width of shake of the lens barrel 2 at the time of shake prevention control may be small. In the example shown in FIG. 1, the first rotation shaft 200a constituting the supporter is disposed so as to support substantially the center, in the direction of height (the vertical direction in the figure), of the lens barrel 2. Moreover, FIG. 1 illustrates a case in which the second rotation shaft 200b is disposed along the gravity axis of the lens barrel 2.

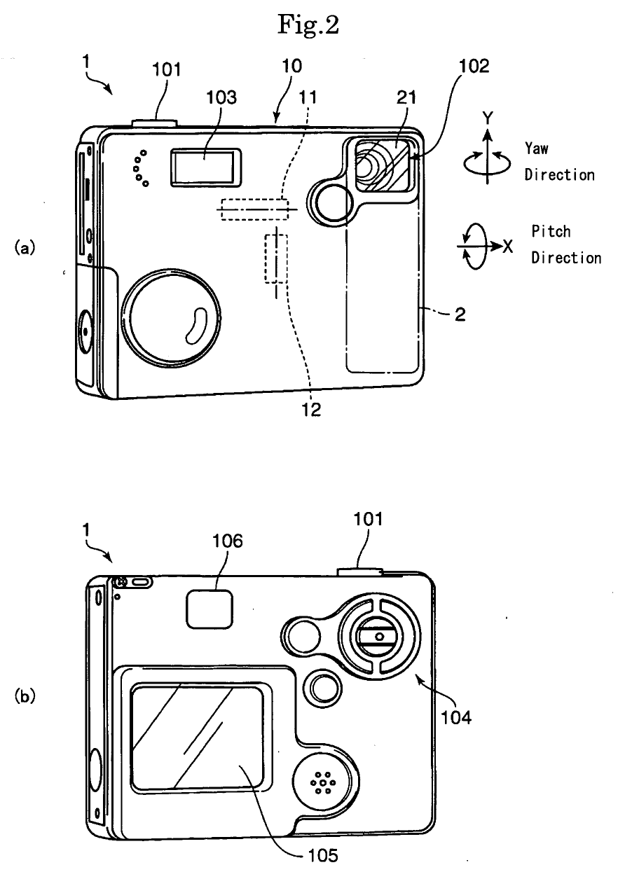

Moreover, the supporter supports the lens barrel so as to be swingable in the yaw direction and in the pitch direction. Further, the lens barrel incorporating camera 1 is provided with, as the actuators, a yaw-direction motor that moves the lens barrel in the yaw direction and a pitch-direction motor that moves the lens barrel in the pitch direction. In this specification, as shown in FIG. 2(a), when the horizontal direction of the camera 1 is the X-axis and the vertical direction thereof is the Y-axis, it is defined that the direction of rotation about the X-axis is the “pitch direction” and the direction of rotation about the Y-axis is the “yaw direction.”

That is, when the lens barrel 2 is a type vertically placed inside the camera body 10 as shown in FIG. 1 and FIG. 2(a) (bent-type lens barrel), the axis in a direction that crosses the direction in which the lens barrel 2 is placed is the pitch-direction axis (X-axis), and the axis in a direction parallel to the direction in which the lens barrel 2 is placed is the yaw-direction axis (Y-axis). Therefore, in the case of FIG. 1, the first rotation shaft 200a corresponds to the pitch-direction axis (X-axis), and the second rotation shaft 200b corresponds to the yaw-direction axis (Y-axis). Moreover, the actuator 3a corresponds to the pitch-direction motor, and the actuator 3b corresponds to the yaw-direction motor. With this structure, the lens barrel 2 is directly driven for shake prevention in the yaw direction and in the pitch direction by the yaw-direction motor and the pitch-direction motor.

Now, concrete embodiments of the lens barrel incorporating camera according to the present invention will be described in detail with reference to the drawings.

### First Embodiment

FIGS. 2(a) and 2(b) are views showing the appearance of a small-size digital camera to which the lens barrel incorporating camera 1 according to the present invention is applied. FIG. 2(a) is a front view. FIG. 2(b) is a rear view. In the lens barrel incorporating camera 1, a release button 101 and the like are disposed on the top surface of the camera body 10, a shooting window 102, a flash 103 and the like are disposed on the front surface, and various operation buttons 104, a display 105 comprising a liquid crystal display (LCD) or the like, an eyepiece lens 106 of a optical finder and the like are disposed on the rear surface.

Inside the camera body 10, the bent-type lens barrel 2 is incorporated that constitutes a taking lens system capturing a subject image through the shooting window 102 and directing it to the solid-state image sensor disposed inside the camera body 10. The bent-type lens barrel 2 does not vary in length even during zooming or focusing. That is, it is a lens barrel that never protrudes out of the camera body 10. Further, inside the camera body 10, a pitch (P) shake detection gyro 11 and a yaw (Ya) shake detection gyro 12 that detect a shake applied to the camera 1 are incorporated. As mentioned above, it is defined that the horizontal direction (width direction) of the camera 1 is the X-axis direction, the vertical direction (height direction) of the camera 1 is the Y-axis direction, the direction of rotation about the X-axis is the pitch (P) direction and the direction of rotation about the Y-axis is the yaw (Ya) direction.

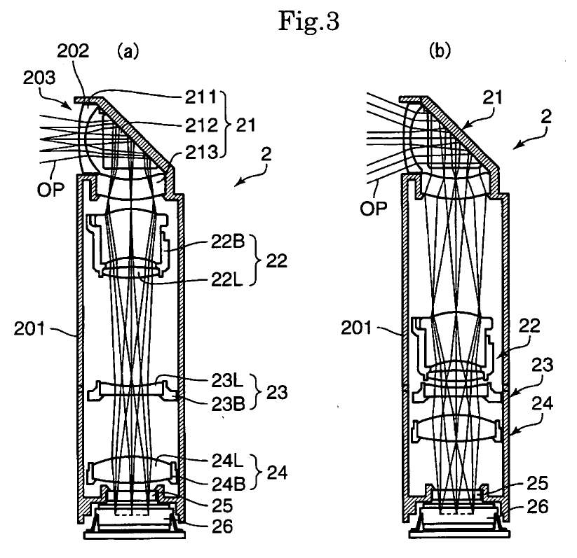

FIGS. 3(a) and 3(b) are cross-sectional views showing an example of the internal structure of the bent-type lens barrel 2. FIG. 3(a) shows a condition where lens units are driven to a telephoto operation condition. FIG. 3(b) shows a condition where the lens units are driven to a wide-angle operation condition. The bent-type lens barrel 2 has a cylindrical shape that is vertically incorporated inside the camera body 10. Moreover, the bent-type lens barrel 2 comprises: a cylindrical part 201 in which the lens units are housed; and a bent part 202 disposed so as to be aligned with the shooting window 102 of the camera body 10 and having an opening 203 through which a subject image enter the lens barrel.

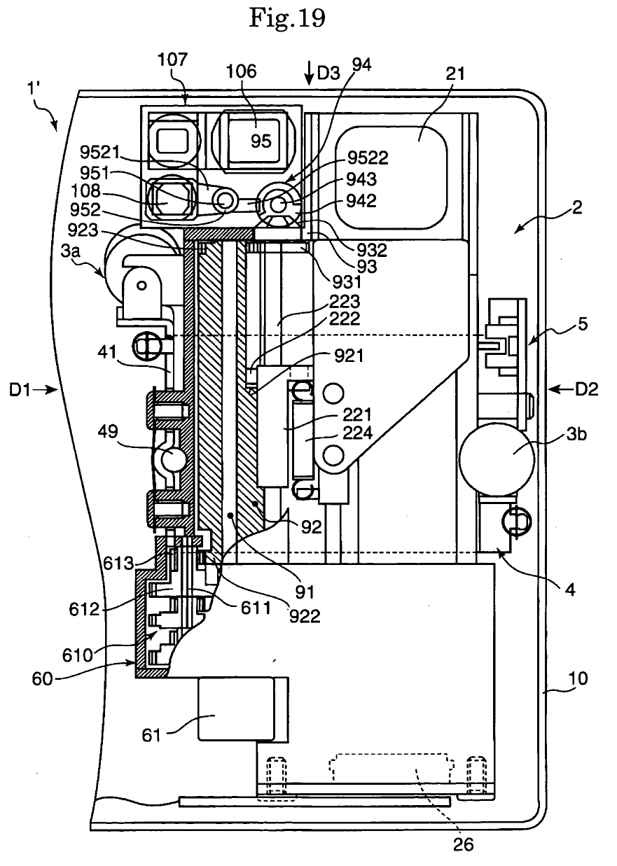

In the bent part 202, the objective lens system 21 is stationarily disposed. The objective lens 21 comprises a first lens element 211 fixed at the opening 203, a prism 212 disposed on the bent part 202, and a second lens element 213 disposed on the entrance side of the cylindrical part 201. Inside the cylindrical part 201, a first zoom lens block 22, a stationary lens block 23 and a second zoom lens block 24 are disposed in a line along the optical axis. The first zoom lens block 22 comprises a lens frame 22B and a zoom lens element 22L fixed by the lens frame 22B. The first zoom lens block 22 is capable of reciprocating by a predetermined amount in the direction of the optical axis by a movement shaft (movement shaft 223 in FIG. 19). Likewise, the second zoom lens block 24 comprises a lens frame 24B and a zoom lens element 24L fixed by the lens frame 24B, and is capable of reciprocating by a predetermined amount in the direction of the optical axis by a non-illustrated movement shaft. On the other hand, the stationary lens block 23 comprises a lens frame 23B stationarily attached to the cylindrical part 201 and a stationary lens element 23L fixed by the lens frame 23B, and does not move in the direction of the optical axis.

On the exit side of the cylindrical part 201 (on the side of the second zoom lens block 24), a solid-state image sensor 26 such as a CCD is fixed through a low-pass filter 25 for moire prevention. That is, when the lens barrel 2 swings, the solid-state image sensor 26 swings integrally therewith. Then, the light ray OP of the subject image entering through the opening 203 is bent at 90° by the prism 212 of the objective lens 21, and passes through the first zoom lens block 22, the stationary lens block 23, the second zoom lens block 24 and the low-pass filter 25 to be directed to a sensor part of the solid-state image sensor 26.

In this structure, when the first zoom lens block 22 and the second zoom lens block 24 are driven by a non-illustrated driver so as to go away from the stationary lens block 23 as shown in FIG. 3(a), the light ray OP of the subject image is imaged on the solid-state image sensor 26 in the telephoto (zoom) condition. On the other hand, when the first zoom lens block 22 and the second zoom lens block 24 are driven so as to approach the stationary lens block 23 as shown in FIG. 3(b), the light ray OP of the subject image is imaged on the solid-state image sensor 26 in the wide-angle condition. As described above, zooming and the like are performed by driving the first zoom lens block 22 and the second zoom lens block 24 in the direction of the optical axis inside the lens barrel 2. Consequently, the lens blocks never protrude out of the cylindrical part 201 of the lens barrel 2, that is, the lens blocks never protrude from the camera body 10.

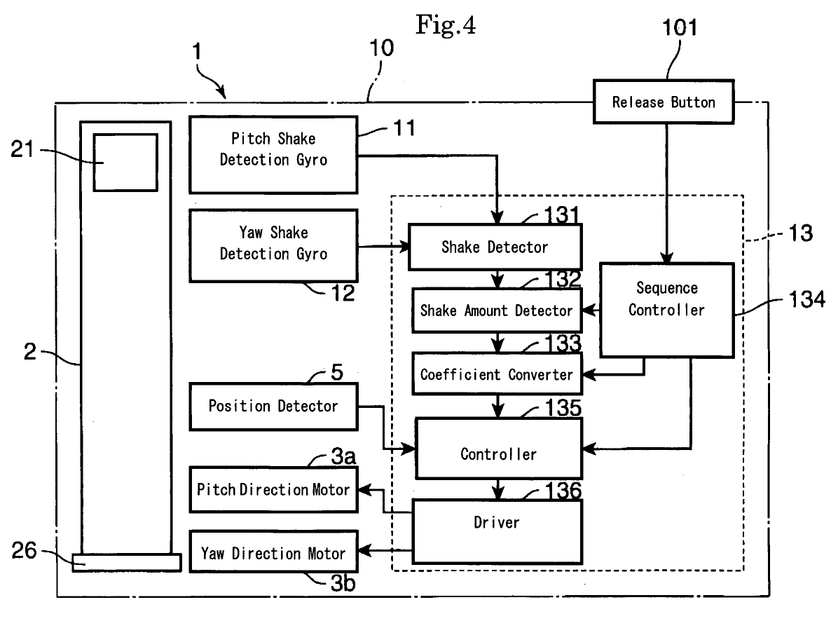

FIG. 4 is a block diagram schematically showing only a relevant part of the structure of the lens barrel incorporating camera 1 according to the present embodiment. In the camera body 10 of the lens barrel incorporating camera 1, the following are provided: the release button 101; the pitch shake detection gyro 11 and the yaw shake detection gyro 12 that detect a shake applied to the camera 1; a circuit arrangement 13 comprising various circuit board blocks; the lens barrel 2 constituting the taking lens system; the pitch-direction motor 3a and the yaw-direction motor 3b that drive the lens barrel 2 for shake prevention; and the position detector 5. The circuit arrangement 13 comprises a shake detector 131, a shake amount detector 132, a coefficient converter 133, a sequence controller 134, a controller 135, and a driver 136.

The release button 101 is an operation switch depressed when the user performs shooting. When the release button 101 is half depressed, the camera 1 is brought into a shooting preparation condition. In this shooting preparation condition, the following are operational: automatic focusing (AF) to automatically bring the subject into focus; automatic exposure (AE) to automatically determine exposure; and a shake prevention control function to prevent image blurring due to a camera shake. To facilitate framing, the shake prevention control function continues working while the release button 101 is depressed. When the release button 101 is fully depressed by the user, shooting is performed. That is, in accordance with the exposure condition determined by AE, exposure control is performed so that the solid-state image sensor 26 is in an appropriate exposure condition.

The pitch shake detection gyro 11 is a gyro sensor that detects a shake in the pitch direction (see FIG. 2) of the camera 1. The yaw shake detection gyro 12 is a gyro sensor that detects a shake in the yaw direction of the camera 1. The gyro sensors used in this embodiment detect, when the object of measurement (the camera body 10 in this embodiment) rotates due to a shake, the angular velocity of the shake. As such gyro sensors, for example, a type may be used that applies a voltage to a piezoelectric element so that the piezoelectric element is in a vibrating condition and detects the angular velocity by extracting, as an electric signal, a distortion due to a Coriolis force caused when an angular velocity due to rotation is applied to the piezoelectric element.

The pitch shake angular velocity signal detected by the pitch shake detection gyro 11 and the yaw shake angular velocity signal detected by the yaw shake detection gyro 12 are inputted to the shake detector 131 of the circuit arrangement 13. The shake detector 131 is provided with filter circuits (a low-pass filter and a high-pass filter) for reducing noise and drift of the detected angular velocity signals, an amplifier circuit for amplifying the angular velocity signals, and the like.

The angular velocity signals outputted from the shake detector 131 are inputted to the shake amount detector 132. The shake amount detector 132 captures the detected angular velocity signals at predetermined time intervals, and outputs the shake amount of the camera 1 in the X-axis direction and the shake amount thereof in the Y-axis direction to the coefficient converter 133 as detx and dety, respectively. Moreover, the coefficient converter 133 converts the shake amounts (detx, dety) in the directions outputted from the shake amount detector 132, into movement amounts (px, py) in the directions, that is, the movement amounts by which the lens barrel 2 is to be moved by the pitch-direction motor 3a and the yaw-direction motor 3b.

The signals representative of the movement amounts (px, py) in the directions outputted from the coefficient converter 133 are inputted to the controller 135. The controller 135 converts the signals representative of the movement amounts (px, py) in the directions into actual driving signals (drvx, drvy) in consideration of the position information from the position detector 5 described later, the operating characteristics of the pitch-direction motor 3a and the yaw-direction motor 3b, and the like. As described above, the controller 135 calculates the correction movement amount for moving the lens barrel 2 by a predetermined amount for shake prevention control based on the detection signals from the pitch shake detection gyro 11 and the yaw shake detection gyro 12. The driving signals (drvx, drvy) in the directions serving as the correction movement amount signals of the lens barrel 2 which driving signals are generated by the controller 135 are inputted to the driver 136 serving as a driver that actually drives the pitch-direction motor 3a and the yaw-direction motor 3b.

The operations of the shake amount detector 132, the coefficient converter 133 and the controller 135 are controlled by the sequence controller 134. That is, when the release button 101 is depressed, the sequence controller 134 controls the shake amount detector 132 so as to capture data signals on the shake amounts (detx, dety) in the directions. Then, the sequence controller 134 controls the coefficient converter 133 so as to convert the shake amounts in the directions into the movement amounts (px, py) in the directions. Then, the sequence controller 134 controls the controller 135 so as to calculate the correction movement amount of the lens barrel 2 based on the movement amounts in the directions. For shake prevention control (camera shake compensation) of the lens barrel 2, this operation is repetitively performed at predetermined time intervals until the release button 101 is fully depressed and exposure is ended.

The pitch-direction motor 3a and the yaw-direction motor 3b move the lens barrel by a predetermined amount in the two axial directions, that is, in the pitch direction and in the yaw direction in accordance with the correction movement amount obtained by the controller 135. As the pitch-direction motor 3a and the yaw-direction motor 3b, stepping motors are used from the viewpoint of high accuracy, ease of driving control and the like. As the stepping motors, normal small-size stepping motors provided with a stator core and a rotor core are applicable. In this case, in order that the lens barrel 2 can be directly driven for shake prevention, it is desirable to connect a screw rotation shaft directly to the rotor core and attach a movement piece (nut or the like) onto the screw rotation shaft. Instead of such rotary stepping motors, linear stepping motors where the rotor moves linearly with respect to the stator may be used.

The position detector 5 detects the home position of the lens barrel 2 supported so as to be swingable, and outputs the position detection result to the controller 135. As such a position detector, a light-reflection-type optical sensor using a semiconductor light emitting device (LED), a slit-type optical sensor or the like may be used.

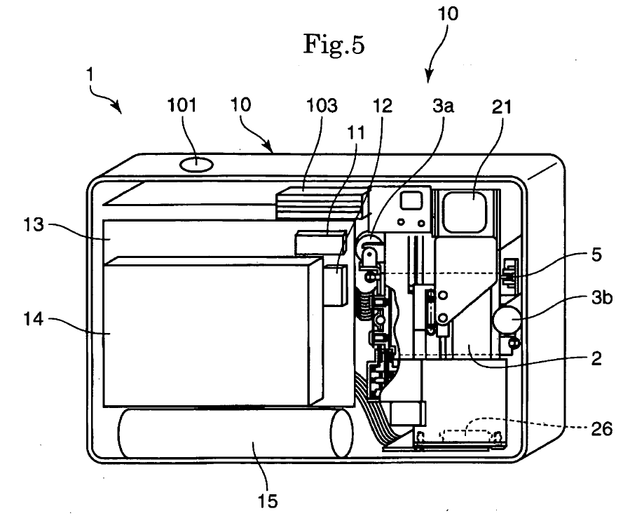

Subsequently, a support mechanism supporting the lens barrel 2 so as to be swingable, a shake prevention driving mechanism of the lens barrel 2 will be described in detail with reference to FIGS. 5 to 10 and 11(a) and 11(b). FIG. 5 is a view showing the condition of incorporation of the lens barrel 2 into the camera body 10 which view corresponds to a condition where the front part of the camera body 10 is removed in the external front view shown in FIG. 2(a).

As shown in FIG. 5, the circuit arrangement 13, a battery 14, a capacitor 15, the release button 101 and the flash 103 are disposed on the left half of the camera body 10. The pitch shake detection gyro 11 and the yaw shake detection gyro 12 are disposed in the vicinity of the center of the camera body 10. The bent-type lens barrel 2 swingably supported by a supporter described later and driven for shake prevention by the pitch-direction motor 3a and the yaw-direction motor 3b is vertically placed and housed in the right half of the camera body 10.

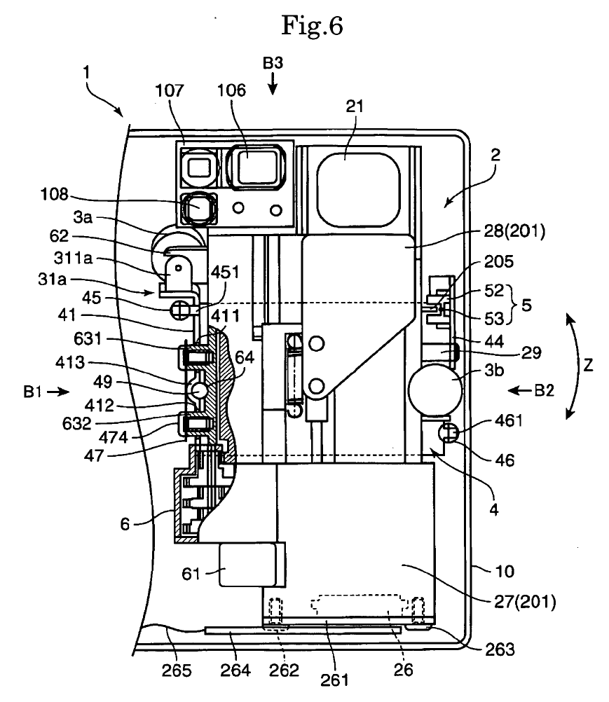

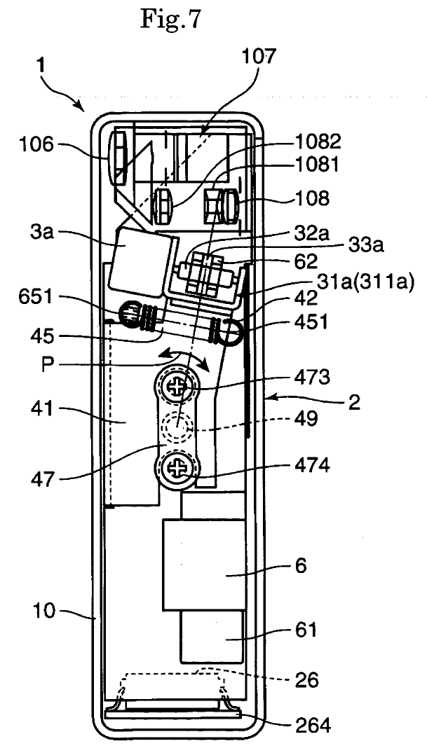

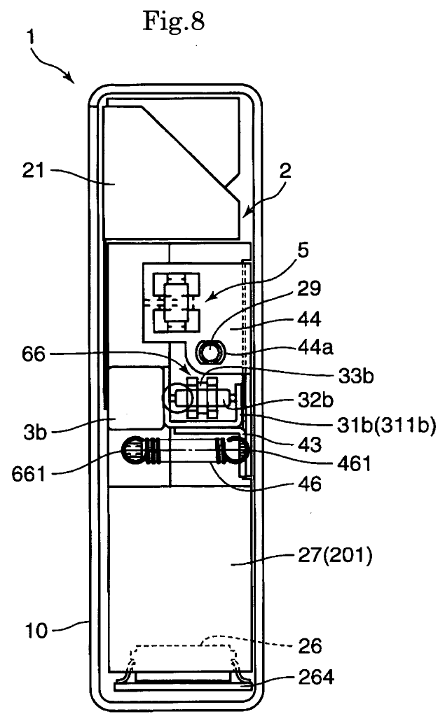

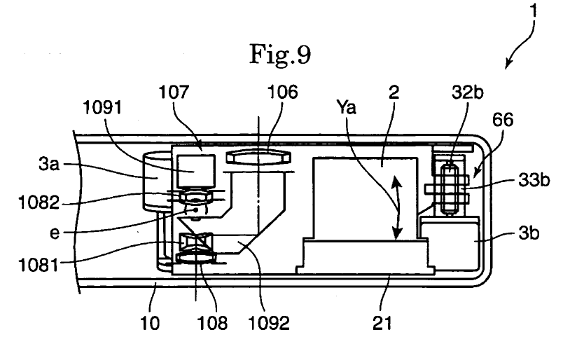

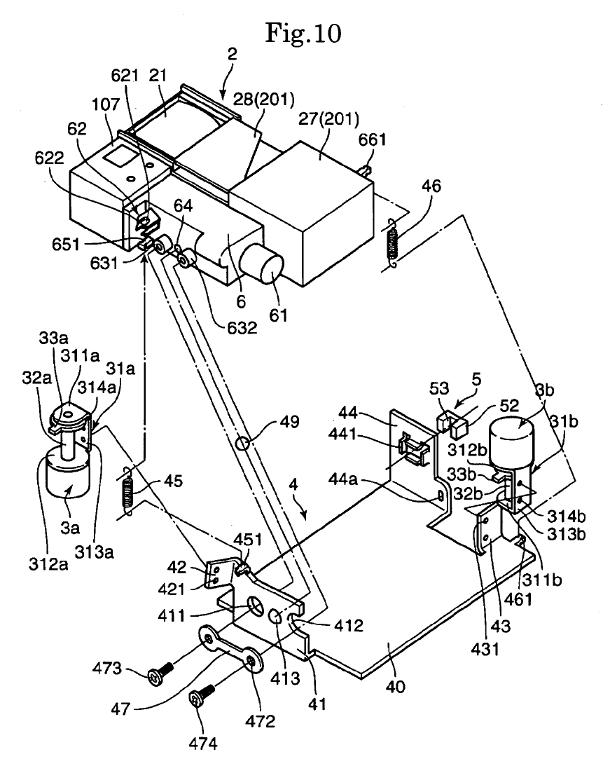

FIG. 6 is a partially cutaway front view showing a relevant part of FIG. 5, that is, the part of the lens barrel 2 so as to be enlarged. FIG. 7 is a side view on the arrow B1 in FIG. 6. FIG. 8 is a side view on the arrow B2. FIG. 9 is a top view on the arrow B3. FIG. 10 is an exploded perspective view of the part of the lens barrel 2.

In FIGS. 6 to 10, the bent-type lens barrel 2 constituting the taking lens system is fixed to the camera body 10, and supported by a support plate 4 having a support point that supports the lens barrel 2 so as to be swingable at least in the yaw direction and in the pitch direction (see, in particular, FIG. 10). The support plate 4 comprises a member formed by punching and bending a metal plate, and is provided with a flat part 40 that is wider than the lens barrel 2 and three vertically bent parts comprising a first bent part 41 provided at one end of the flat part 40 and a second bent part 43 and a third bent part 44 provided at the other end.

The first bent part 41 is for holding a ball bearing 49 (serving as the support point of the lens barrel 2) made of a steel ball or the like and interposed between the support plate 4 and the lens barrel 2, and forming a pivot bearing. The first bent part 41 is provided with a concave portion 413 for receiving one side of the ball bearing 49, and a through hole 411 and a notch 412 for attaching a plate spring 47 for applying a pressing force (sandwiching force) to the ball bearing 49. Moreover, a bent part is provided at the upper end of the first bent part 41, and the bent part is used as a motor fixing plate 42 for attaching the pitch-direction motor 3a. Further, the first bent part 41 is provided with a comparatively narrow bent part. The narrow bent part is used as an attachment part 451 of a coil spring 45 that absorbs the backlash in the pitch direction between the support plate 4 and the lens barrel 2.

The second bent part 43 is used as a motor fixing plate for attaching the yaw-direction motor 3b. In the vicinity of the second bent part 43, an attachment part 461 for attaching a coil spring 46 that absorbs the backlash in the yaw direction between the support plate 4 and the lens barrel 2 is provided in a protruding condition. The third bent part 44 is used as a plate for attaching the position detector 5 for detecting the home position of the lens barrel 2.

In the present embodiment, as shown in FIG. 10, as the lens barrel 2, one to which a optical finder block 107 and a zoom driving unit 6 having a zoom actuator 61 are integrally attached is shown as an example. Therefore, in the present embodiment, not only the lens barrel 2 but also the finder block 107 and the zoom driving unit 6 are integrally swung (driven for shake prevention). While the lens barrel 2 has the structure shown in FIG. 3 as the internal structure thereof, a base 27 disposed outside the cylindrical part 201 (see FIG. 3) and a zoom cam ring 28 appear in FIGS. 6 to 10.

The above-described optical finder block 107 is provided with, as shown in FIG. 9, an eyepiece lens 106, an objective lens 108, a first optical lens 1081 having negative optical power and positive optical power and a second optical lens 1082 (zooming structure), and setting a predetermined finder focal length, and a first prism 1091 and a second prism 1092 forming the optical path between the objective lens 108 to the eyepiece lens 106. In this embodiment, an example is shown in which the finder block 107 is integrated with the lens barrel 2 in a condition of being additionally provided at the upper end of the lens barrel 2, and as a consequence, the objective lens 108 of the optical finder is disposed in the vicinity of the optical lens 21 of the taking lens system. According to this structure, since the objective lenses of these are close to each other, the shake prevention driving provided for the lens barrel 2 is also provided for the finder block 107 with high responsivity, so that the shake prevention accuracy of the finder block 107 can be improved.

The solid-state image sensor 26 supported by a fixing plate 261 is attached to the bottom of the base 27 by an attaching screw 263 (not shown in FIG. 10). Therefore, the solid-state image sensor 26 also swings integrally with the lens barrel 2. This simplifies the optical system between the lens barrel 2 and the solid-state image sensor 26. A driving plate 264 of the solid-state image sensor 26 is also fixed to the fixing plate 261, and by electrically connecting the driving plate 264 and other circuits by a flexible electric wire 265, expansion and contraction due to a swing of the lens barrel 2 can be handled.

A concave portion 64 holding the other side of the ball bearing 49 is provided on the surface of the lens barrel 2 (the zoom driving unit 6 integrated with the lens barrel 2) opposing the first bent part 41 of the support plate 4. Moreover, a first bearing 631 and a second bearing 632 are provided in a protruding condition in positions corresponding to the through hole 411 and the notch 412 of the first bent part 41, respectively. As shown in FIG. 6, the lens barrel 2 is attached to the support plate 4 under a condition where the first bearing 631 and the second bearing 632 are engaged with the through hole 411 and the notch 412, respectively, and the ball bearing 49 is sandwiched between the concave portion 413 of the first bent part 41 and the concave portion 64 on the zoom driving unit side. The plate spring 47 is disposed on the rear side of the first bent part 41. The plate spring 47 is fixed to the first bearing 631 and the second bearing 632 by attaching screws 473 and 474 through screw holes 471 and 472 provided in the plate spring 47, the through hole 411 and the notch 412. By the pushing force of the plate spring 47, a side (the side where the concave portion 64 is situated) of the lens barrel 2 is pressed against the first bent part 41 of the support plate 4. With this, the ball bearing 49 is held with stability. The outer diameter of the first bearing 631 is smaller than the diameter of the through hole 411, so that the lens barrel 2 can be moved by a predetermined amount in the pitch direction even under a condition where the first bearing 631 and the through hole 411 are engaged with each other.

In the vicinity of the first bearing 631, an attachment part 651 for attaching the coil spring 45 is provided in a protruding condition. As shown in FIG. 7, the hooks at the ends of the coil spring 45 are hitched between the attachment part 651 and the attachment part 451 provided on the first bent part 41 in a protruding condition, and the backlash in the pitch direction between the support plate 4 and the lens barrel 2 is absorbed by the bridging of the coil spring 45.

The pitch-direction motor 3a is provided with, as shown in FIG. 10, a screw rotation shaft 32a and a nut 33a that is movable in the axial direction of the screw rotation shaft 32a in accordance with the rotation of the screw rotation shaft 32a. A U-shaped motor support metal part 31a is inserted into the screw rotation shaft 32a. The motor support metal part 31a comprises: an attachment part 313a (parallel to the axial direction of the screw rotation shaft 32a) having a pin hole 314a; a bearing 311a receiving the top end of the screw rotation shaft 32a; and a receiving plate 312a on the bottom end side of the screw rotation shaft 32a.

The attachment part 313a of the motor support metal part 31a abuts on the motor fixing plate 42 provided on the first bent part 41, and these are fixed by use of the pin hole 314a provided in the attachment part 313a and a pin hole 421 provided in the motor fixing plate 42.

In order that the movement force in the pitch direction can be supplied to the lens barrel 2, the pitch-direction motor 3a is disposed so that the axial direction of the screw rotation shaft 32a thereof (that is, the movement direction of the nut 33a) is the rotation direction of the pitch-direction axis. On the side of the zoom driving unit 6 integrated with the lens barrel 2, a nut receiver 62 is provided in a protruding condition in a position interfering with the nut 33a. The nut receiver 62 is provided with a groove 621 receiving the screw rotation shaft 32a and a slit 622 in which the nut 33a is fitted.

Since the nut 33a and the nut receiver 62 interfere with each other as shown in FIG. 7, the nut receiver 62 acts as the point of action of the movement to the lens barrel 2 by the pitch-direction motor 3a. Consequently, the movement force is transmitted through the nut receiver 62 by a movement of the nut 33a along the screw rotation shaft 32a due to normal or reverse rotation of the pitch-direction motor 3a. Then, the lens barrel 2 is moved in the direction shown by the arrow P in the figure (pitch direction) with the ball bearing 49, serving as the support point of the unit including the lens barrel 2, as the base point. According to this structure, the driving force of the pitch-direction motor 3a is directly transmitted to the lens barrel 2 through the nut receiver 62. Consequently, the power transmitting mechanism can be simplified as well as the backlash in the pitch direction is eliminated by the coil spring 45, so that the movement error of the lens barrel 2 can be suppressed.

On the other hand, the yaw-direction motor 3b is also provided with a screw rotation shaft 32b and a nut 33b that is movable in the axial direction of the screw rotation shaft 32b in accordance with the rotation of the screw rotation shaft 32b (FIG. 10). Moreover, a motor support metal part 31b having an attachment part 313b having a pin hole 314b, a bearing 311b receiving the top end of the screw rotation shaft 32b, and a receiving plate 312b on the bottom end side of the screw rotation shaft 32b is inserted in the screw rotation shaft 32b.

The attachment part 313b of the motor support metal part 31b abuts on the second bent part 43 of the support plate 4, and these are fixed by use of the pin hole 314b provided in the attachment part 313b and a pin hole 431 provided in the second bent part 43. As shown in FIGS. 8 and 10, on a side wall (the surface opposite to the surface where the concave portion 64 is formed) of the lens barrel 2, an attachment part 661 for attaching the coil spring 46 is provided in a protruding condition. The hooks at the ends of the coil spring 46 are hitched between the attachment part 661 and the attachment part 461 provided on the support plate 4 in a protruding condition, so that the backlash in the yaw direction between the support plate 4 and the lens barrel 2 is absorbed by the bridging of the coil spring 46.

In order that the movement force in the yaw direction can be supplied to the lens barrel 2, the yaw-direction motor 3b is disposed so that the axial direction of the screw rotation shaft 32b thereof (that is, the movement direction of the nut 33b) is the rotation direction of the yaw-direction axis. On the side wall of the lens barrel 2, a nut receiver 66 that is similar to the nut receiver 62 is provided in a position interfering with the nut 33b (See FIG. 8. The nut receiver 66 is hidden in FIG. 10).

As shown in FIG. 9, the nut 33b and the nut receiver 66 are provided so as to interfere with each other. Thus, the nut receiver 66 acts as the point of action of the movement to the lens barrel 2 by the yaw-direction motor 3b. Consequently, the movement force is transmitted through the nut receiver 66 by a movement of the nut 33b along the screw rotation shaft 32b due to normal or reverse rotation of the yaw-direction motor 3b. Then, the lens barrel 2 is moved in the direction shown by the arrow Ya in the figure (yaw direction) with the ball bearing 49, serving as the support point of the unit including the lens barrel 2, as the base point (represented by reference designation e in FIG. 9).

Further, as shown in FIG. 6, on the lens barrel 2, a rolling restricting shaft 29 extending substantially in a radial direction (the direction of the X-axis shown in FIG. 2) from the ball bearing 49 serving as the support point is provided in a protruding condition. The rolling restricting shaft 29 is engaged with an elongate hole 44a (see FIGS. 8 and 10) provided in the third bent part 44 of the support plate 4. When the lens barrel 2 is moved in the yaw direction, the elongate hole 44a guides the movement of the rolling restricting shaft 29, and when the lens barrel 2 is moved in the pitch direction, the rolling restricting shaft 29 rotates in the elongate hole. By the rolling restricting shaft 29 being engaged with the elongate hole 44a, the backlash in the rolling direction (the direction shown by the arrow Z in FIG. 6) of the lens barrel 2 is eliminated, so that the lens barrel can be moved with high accuracy.

While as the rolling restricting shaft 29, one provided so as to extend in the X-axis direction from the ball bearing 49 serving as the support point thereof is shown in FIG. 6, a rolling restricting shaft may be provided so as to extend in the Y-axis direction shown in FIG. 2 from the ball bearing serving as the support point thereof in order that the backlash in the rolling direction is eliminated. Further, while the rolling restricting shaft 29 is provided on the lens barrel 2 and the elongate hole 44a is provided in the support plate 4 in FIG. 6, a structure may be adopted such that the rolling restricting shaft 29 is provided on the support plate 4 and the elongate hole 44a is provided on the lens barrel 2. With this structure, the backlash of the lens barrel 2 in the rolling direction is also eliminated, so that the lens barrel 2 can be moved with high accuracy.

The position detector 5 is attached to an opening 441 provided in the third bent part 44 of the support plate 4. The position detector 5 is provided with a sensor main unit 52 in which a light emitting element (not shown) that emits measurement light and a light receiving element that receives the measurement light are disposed so as to be opposed to each other with a measurement slit 53 in between. The position detector 5 is for detecting the home position of the lens barrel 2, specifically, for detecting the resting position of the lens barrel 2 under a condition where no shake is applied to the camera 1.

As shown in FIG. 6, the position detector 5 is disposed so that the measurement slit 53 faces toward the lens barrel 2, and a measurement piece 205 protruding from the lens barrel 2 is fitted in the measurement slit 53. When the lens barrel 2 is in the home position, the optical path between the light emitting element and the light receiving element of the sensor main unit 52 is intercepted by the measurement piece 205. When the lens barrel 2 is shifted from the home position, the intercepted condition by the measurement piece 205 is canceled. Consequently, the output of the light receiving element is ON or OFF according to whether the lens barrel 2 is in the home position or not, and the positional condition of the lens barrel 2 is detected by a logical comparison thereof (1 or 0).

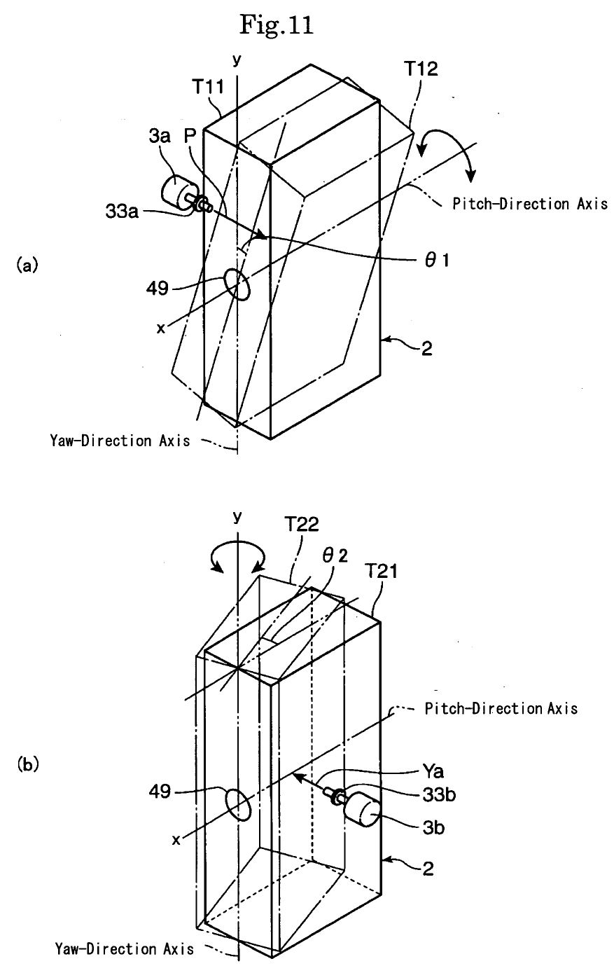

FIGS. 11(a) and 11(b) are views schematically showing the above-described condition of movement of the lens barrel 2 by the pitch-direction motor 3a and the yaw-direction motor 3b. As shown in FIG. 11(a), when the pitch-direction motor 3a is driven in the normal direction to move the nut 33a forward, the lens barrel 2 is moved in the direction of the arrow P in the figure (pitch direction) with the ball bearing 49, serving as the support point of its swing, as the base point. That is, the lens barrel 2 is rotated by a predetermined angle θ1 in the rotation direction of the pitch-direction axis from the position shown by the solid line T11 in the figure to the position shown by the chain line T12 in the figure.

When the pitch-direction motor 3a is driven in the reverse direction to move the nut 33a backward, the lens barrel 2 is moved in the direction opposite to the arrow P in the figure with the ball bearing 49 as the base point. With this structure, the lens barrel 2 is rotatable in the pitch direction by the pitch-direction motor 3a. Since the lens barrel 2 swings in a small space of the inside of the camera body 10, the actual movement amount of the lens barrel 2 is slight, and in FIG. 11, the movement amount is exaggerated.

As shown in FIG. 11(b), when the yaw-direction motor 3b is driven in the normal direction to move the nut 33b forward, the lens barrel 2 is moved in the direction of the arrow Ya in the figure (yaw direction) with the ball bearing 49, serving as the support point of its swing, as the base point. That is, the lens barrel 2 is rotated by a predetermined angle θ2 in the rotation direction of the yaw-direction axis from the position shown by the solid line T21 in the figure to the position shown by the chain line T22 in the figure. When the yaw-direction motor 3b is driven in the reverse direction to move the nut 33b backward, the lens barrel 2 is moved in the direction opposite to the arrow Ya in the figure also with the ball bearing 49 as the base point. With this structure, the lens barrel 2 is rotatable in the yaw direction by the yaw-direction motor 3b.

As described above, the lens barrel 2 is moved in the pitch direction and in the yaw direction by the pitch-direction motor 3a and the yaw-direction motor 3b, respectively. The movement amount and movement direction thereof are controlled by the driving signals (drvx, drvy) in the pitch direction and in the yaw direction obtained by the calculation by the controller 135 based on the shake amount (camera shake amount) detected by the pitch shake detection gyro 11 and the yaw shake detection gyro 12, the output information of the position detector 5 and the like. Consequently, even if a shake due to a hand shake is applied to the camera 1, the lens barrel 2 is appropriately driven for shake prevention by the pitch-direction motor 3a and the yaw-direction motor 3b, so that blurring of shot images due to camera shake can be prevented.

In particular, in the present embodiment, the pitch-direction motor 3a and the yaw-direction motor 3b are disposed close to the axis lines of the yaw-direction axis and the pitch-direction axis with the support point, by the ball bearing 49 serving as a pivot bearing, as the base point, and further, the movement directions of the nuts 33a and 33b which are movement pieces of the motors are the rotation directions. That is, since the lens barrel 2 is directly moved in the pitch direction and in the yaw direction, the movement force is directly transmitted to the lens barrel 2 through the nut receivers 62 and 66 which are points of action of the movement without passing through any other mechanism, so that the mechanism to transmit the movement force to the lens barrel 2 can be simplified. Moreover, the lens barrel 2 can be efficiently moved with good balance. Further, by using stepping motors as the pitch-direction motor 3a and the yaw-direction motor 3b, the driving control is easy and the highly accurate movement of the stepping motors can be directly transmitted to the lens barrel 2, so that the lens barrel 2 can be driven for shake prevention with high accuracy.

In the lens barrel incorporating camera 1 according to the present embodiment, the distance from the ball bearing 49 serving as the support point to the pitch-direction motor 3a and the distance from the ball bearing 49 to the yaw-direction motor 3b are substantially different from each other. However, these distances may be the same. According to this structure, the relationship between the driving force of the pitch-direction motor 3a and the movement amount of the lens barrel 2 and the relationship between the yaw-direction motor 3b and the movement amount of the lens barrel 2 can be made substantially the same. Consequently, the resolutions of the movement amount controls of the lens barrel 2 in the yaw direction and in the pitch direction can be unified, so that the lens barrel 2 can be driven for shake prevention with a simple calculation.

Further, in this embodiment, since the finder block 107 is integrally attached to the lens barrel 2, when the lens barrel 2 is driven for shake prevention, the finder block 107 is driven for shake prevention in synchronism therewith. With this structure, the user can confirm the effect of shake prevention driving through the eyepiece lens 106 of the finder block 107.

### Second Embodiment

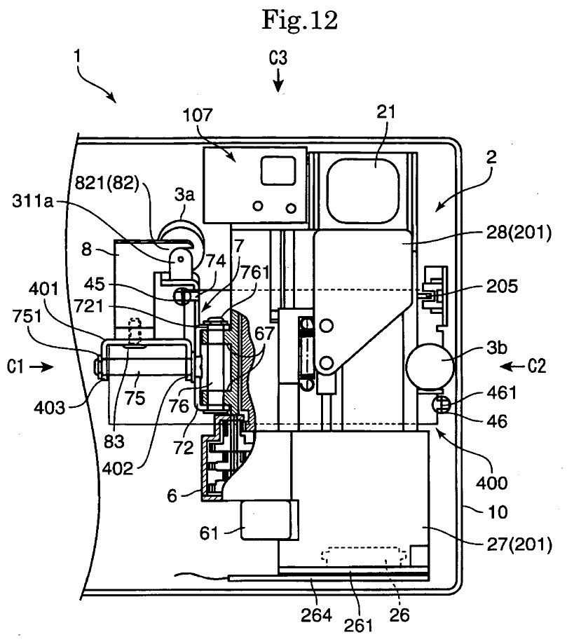

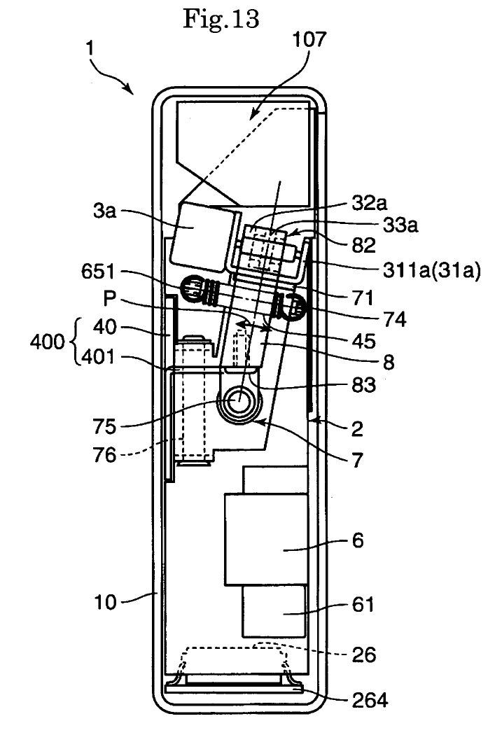

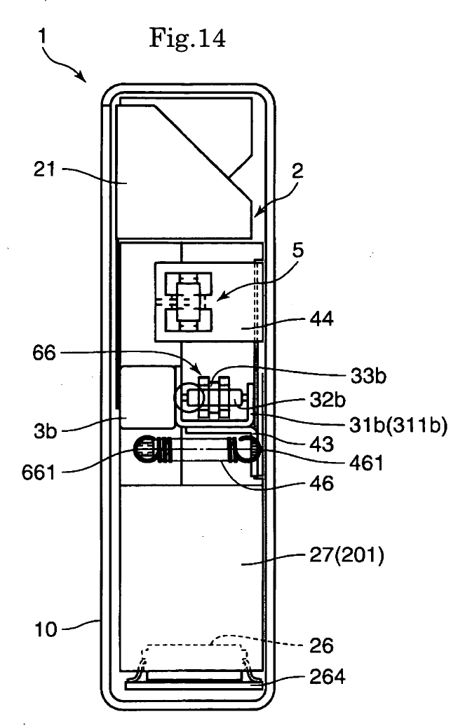

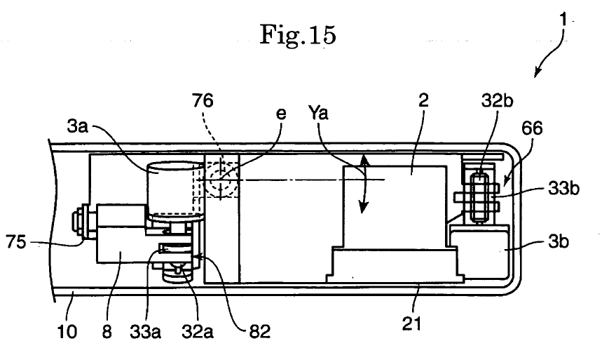

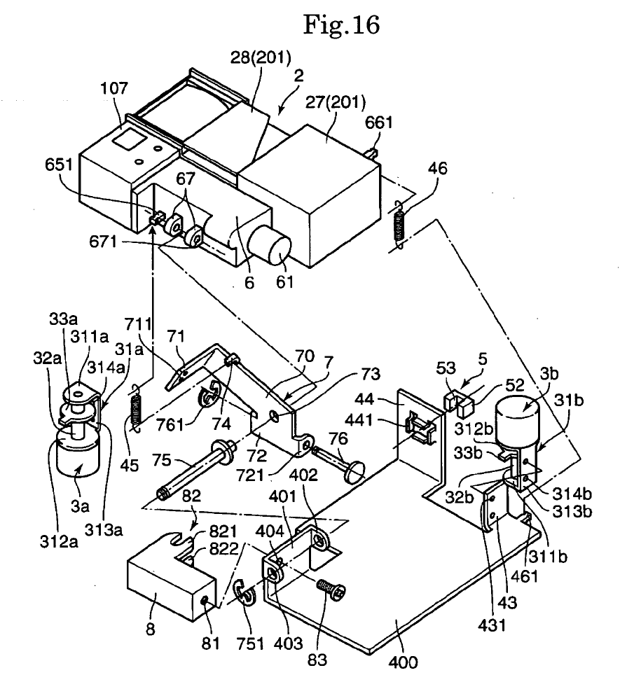

Next, a second embodiment of the present invention will be described. This embodiment relates to a support mechanism that supports the lens barrel 2 so as to be swingable, and the control portion and the structure of the lens barrel 2 itself are similar to those of the first embodiment. Therefore, only the support mechanism will be described in detail with reference to FIGS. 12 to 16. FIG. 12 is a partially cutaway front view showing the part of the lens barrel 2, which is a relevant part of the present invention, so as to be enlarged. FIG. 13 is a side view on the arrow C1 in FIG. 12. FIG. 14 is a side view on the arrow C2 in FIG. 12. FIG. 15 is a top view on the arrow C3 in FIG. 12. FIG. 16 is an exploded perspective view of the part of the lens barrel 2. In FIGS. 12 to 16, the parts denoted by the same reference numerals as those of FIGS. 5 to 10 and FIGS. 11(a) and 11(b) described in the first embodiment are the same parts, and descriptions of these same parts are omitted or given briefly.

In FIGS. 12 to 16, the bent-type lens barrel 2 constituting the taking lens system is swingably supported in the yaw direction and in the pitch direction by a support plate comprising a first support plate (pitch plate) 400 fixed to the camera body 10 and a second support plate (yaw plate) 7 attached to the pitch plate 400 (see, in particular, FIG. 16).

The pitch plate 400 comprises a member formed by punching and bending a metal plate, and is provided with the flat part 40 that is wider than the lens barrel 2 and three vertically bent parts comprising a first bent part 401 provided at one end of the flat part 40 and the second bent part 43 and the third bent part 44 provided at the other end. The first bent part 401 is provided with a pair of bearings (first bearings) 402 and 403 provided at the upper end of the bent part and extending in the pitch direction and a through hole 404 for attaching an auxiliary driving piece 8. The second bent part 43 and the third bent part 44 will not be described because they are the same as those of the support plate 4 used in the first embodiment.

The auxiliary driving piece 8 is provided with a nut receiver 82 interfering with the nut 33a as the movement piece of the pitch-direction motor 3a. The nut receiver 82 is provided with a groove 821 receiving the screw rotation shaft 32a and a slit 822 in which the nut 33a is fitted. The auxiliary driving piece 8 is fixed to the first bent part 401 by a set screw 83 through the through hole 404 of the first bent part 401 by use of a screw hole 81 provided in the bottom surface.

The yaw plate 7 comprises a rectangular metal member where a bent part is formed on one side of a main part 70 and a bearing is formed on the other side thereof. The bent part is used as a motor board fixer 71 for attaching the pitch-direction motor 3a. The bearing is used as a shaft supporter 72 having a second bearing 721 that enables the subsequently described shaft connection with the lens barrel 2. Further, the yaw plate 7 is provided with an attachment hole 73 for fixing a first shaft 75 and an attachment part 74 for enabling one end of the coil spring 45 to be attached.

The first shaft 75 is a rotation shaft for making the yaw plate 7 rotatable, and is rotatably supported by the first bearings 402 and 403 provided on the first bent part 401. That is, the first shaft 75 is inserted in the first bearings 402 and 403, and one end of the first shaft 75 is fixed to the attachment hole 73 of the yaw plate 7 and a fastening member 751 for preventing coming off is attached to the other end thereof. Consequently, when the first shaft 75 rotates, in response thereto, the yaw plate 7 rotates about the axis of the first shaft 75. Although described later, the first shaft 75 acts as the rotation support point for rotating the lens barrel 2 in the pitch direction.

The pitch-direction motor 3a is provided with, as shown in FIG. 16, the screw rotation shaft 32a and the nut 33a that is movable in the axial direction of the screw rotation shaft 32a in accordance with the rotation of the screw rotation shaft 32a. The U-shaped motor support metal part 31a is inserted into the screw rotation shaft 32a like in the first embodiment. The attachment part 313a of the motor support metal part 31a abuts on the motor board fixer 71 provided on the yaw plate 7, and these are fixed by use of a pin hole 314a provided in the attachment part 313a and a pin hole 711 provided in the motor board fixer 71.

In the present embodiment, the finder block 107 and the zoom driving unit 6 having the zoom actuator 61 are also integrally attached to the lens barrel 2. On the surface of the lens barrel 2 (the zoom driving unit 6 integrated with the lens barrel 2) opposite to the yaw plate 7, a pair of bearings 67 having a through hole 671 for inserting a second shaft 76 therethrough is provided in a protruding condition.

The pair of bearings 67 and the shaft supporter 72 of the yaw plate 7 are coupled together by the second shaft 76. That is, the second shaft 76 is inserted so as to pass through the second bearing 721 comprising a pair of pin holes provided in the shaft supporter 72 and the through hole of the bearings 67 on the side of the lens barrel 2. The tip of the second shaft 76 is fixed by a fastening member 761 for preventing coming off. The second shaft 76 and the first shaft 75 are disposed so that their shaft support directions are orthogonal to each other. That is, the second shaft 76 acts as the rotation support point for rotating the lens barrel 2 in the yaw direction.

In the vicinity of the pair of bearings 67, the attachment part 651 for attaching the coil spring 45 is provided in a protruding condition. As shown in FIG. 13, the hooks at the ends of the coil spring 45 are hitched between the attachment part 651 and the attachment part 74 provided on the yaw plate 7 in a protruding condition. With this structure, the backlash in the pitch direction between the yaw plate 7 (and the pitch plate 400) and the lens barrel 2 is absorbed by the bridging of the coil spring 45.

In order that the movement force in the pitch direction can be supplied to the lens barrel 2, the pitch-direction motor 3a is disposed so that the axial direction of the screw rotation shaft 32a thereof (that is, the movement direction of the nut 33a) is the rotation direction of the pitch-direction axis. On the auxiliary driving piece 8 integrated with the pitch plate 400, the above-described nut receiver 82 is provided in a protruding condition in a position interfering with the nut 33a. Since the nut 33a and the nut receiver 82 interfere with each other as shown in FIG. 13, the nut receiver 82 acts as the point of action of the movement to the lens barrel 2 by the pitch-direction motor 3a. That is, the movement force is transmitted to the nut receiver 82 of the auxiliary driving piece 8 by a movement of the nut 33a along the screw rotation shaft 32a due to normal or reverse rotation of the pitch-direction motor 3a. Since the auxiliary driving piece 8 is fixed to the pitch plate 400 fixed to the camera body 10, the yaw plate 7 to which the pitch-direction motor 3a is fixed rotates about the first shaft 75, so that the rotation force thereof is transmitted to the lens barrel 2 through the second shaft 76. In this manner, in the unit including the lens barrel 2, the lens barrel 2 is moved in the direction shown by the arrow P (pitch direction) with the first shaft 75 (first bearing), serving as the support point of the rotation in the pitch direction, as the axis.

On the other hand, the yaw-direction motor 3b is also provided with the screw rotation shaft 32b and the nut 33b that is movable in the axial direction of the screw rotation shaft 32b in accordance with the rotation of the screw rotation shaft 32b, and the motor support metal part 31b is inserted in the screw rotation shaft 32b (FIG. 16). Like in the first embodiment, the attachment part 313b of the motor support metal part 31b abuts on the second bent part 43 of the pitch plate 400, and these are fixed. Moreover, like in the first embodiment, as shown in FIGS. 14 and 16, the backlash in the yaw direction between the pitch plate 400 and the lens barrel 2 is absorbed by bridging the coil spring 46 between the attachment part 661 on the side of the lens barrel 2 and the attachment part 461 provided on the pitch plate 400 in a protruding condition. Further, like in the first embodiment, the position detector 5 detects the home position of the lens barrel 2.

In order that the movement force in the yaw direction can be supplied to the lens barrel 2, the yaw-direction motor 3b is disposed so that the axial direction of the screw rotation shaft 32b thereof (that is, the movement direction of the nut 33b) is the rotation direction of the yaw-direction axis. On the side wall of the lens barrel 2, the nut receiver 66 that is similar to the nut receiver 62 is provided in a position interfering with the nut 33b (See FIG. 14. The nut receiver 66 is hidden in FIG. 16).

As shown in FIG. 15, the nut 33b and the nut receiver 66 are provided so as to interfere with each other. Thus, the nut receiver 66 acts as the point of action of the movement to the lens barrel 2 by the yaw-direction motor 3b. Consequently, the movement force is transmitted to the lens barrel 2 through the nut receiver 66 by a movement of the nut 33b along the screw rotation shaft 32b due to normal or reverse rotation of the yaw-direction motor 3b. Then, in the unit including the lens barrel 2, the lens barrel 2 is moved in the direction shown by the arrow Ya in the figure (yaw direction) with the second shaft 76 (second bearing), serving as the rotation support point in the yaw direction, as the axis (represented by reference designation e in FIG. 15).

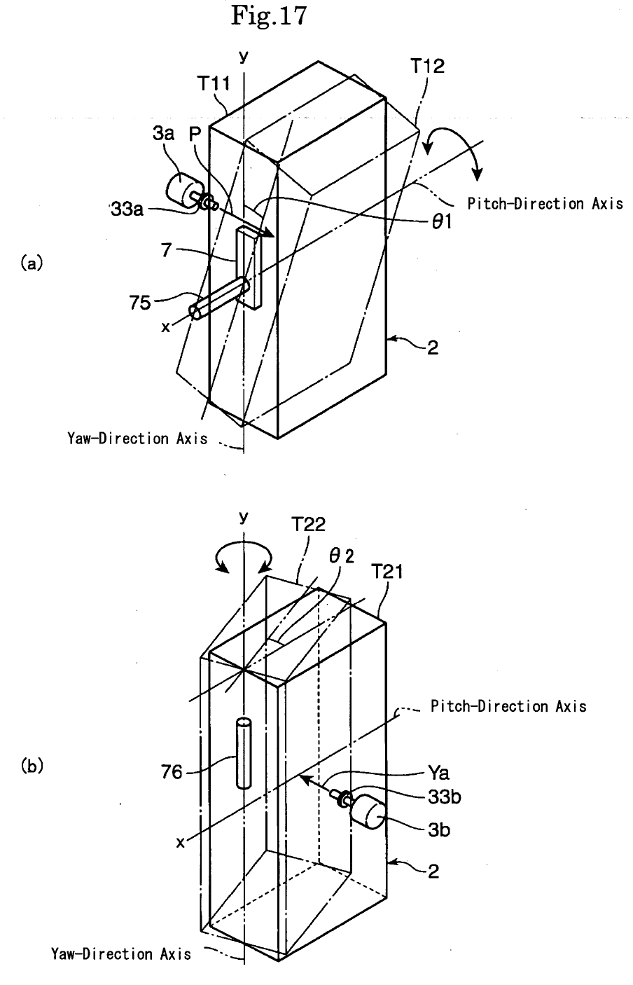

FIGS. 17(a) and 17(b) are views schematically showing the above-described condition of movement of the lens barrel 2 by the pitch-direction motor 3a and the yaw-direction motor 3b. First, as shown in FIG. 11(a), when the pitch-direction motor 3a provided on the yaw plate 7 is driven in the normal direction to move the nut 33a forward, the lens barrel 2 is moved in the direction of the arrow P in the figure (pitch direction) with the first shaft 75 (first bearing), serving as the support point of the rotation in the pitch direction, as the shaft support point. That is, the yaw plate 7 made swingable by the first shaft 75 with respect to the pitch plate 400 is rotated by driving the pitch-direction motor 3a, and the rotation force is transmitted to the lens barrel 2 through the second shaft 76 integrated with the yaw plate 7 and coupled also to the lens barrel 2. In this manner, the lens barrel 2 is rotated by a predetermined angle θ1 in the rotation direction of the pitch-direction axis from the position shown by the solid line T11 in the figure to the position shown by the chain line T12 in the figure.

When the pitch-direction motor 3a is driven in the reverse direction to move the nut 33a backward, the lens barrel 2 is moved in the direction opposite to the arrow P in the figure also with the first shaft 75 as the shaft support point. With this structure, the lens barrel 2 is rotatable in the pitch direction by the pitch-direction motor 3a.

Next, as shown in FIG. 17(b), when the yaw-direction motor 3b is driven in the normal direction to move the nut 33b forward, the lens barrel 2 is moved in the direction of the arrow Ya in the figure (yaw direction) with the second shaft 76 (second bearing), serving as the support point of the rotation in the yaw direction, as the shaft support point. That is, the lens barrel 2 is rotated by a predetermined angle θ2 in the rotation direction of the yaw-direction axis from the position shown by the solid line T21 in the figure to the position shown by the chain line T22 in the figure. When the yaw-direction motor 3b is driven in the reverse direction to move the nut 33b backward, the lens barrel 2 is moved in the direction opposite to the arrow Ya in the figure also with the ball bearing 49 as the base point. With this structure, the lens barrel 2 is rotatable in the yaw direction by the yaw-direction motor 3b.

As described above, the lens barrel 2 is moved in the pitch direction and in the yaw direction by the pitch-direction motor 3a and the yaw-direction motor 3b, respectively. The movement amount and movement direction thereof are controlled by the driving signals (drvx, drvy) in the pitch direction and in the yaw direction obtained by the calculationby the controller 135 based on the shake amount (camera shake amount) detected by the pitch shake detection gyro 11 and the yaw shake detection gyro 12, the output information of the position detector 5 and the like. Consequently, even if a shake due to a hand shake is applied to the camera 1, the lens barrel 2 is appropriately driven for shake prevention by the pitch-direction motor 3a and the yaw-direction motor 3b, so that blurring of shot images due to camera shake can be prevented.

According to the present embodiment, the lens barrel 2 is supported so as to be swingable only in the pitch direction and the yaw direction. That is, the lens barrel 2 is supported so as to be swingable about the first shaft 75 (first bearing) in the pitch direction and to be swingable about the second shaft 76 (second bearing) in the yaw direction. Consequently, the lens barrel can be stably rotated about each shaft.

### Third Embodiment

Next, a third embodiment will be described. This embodiment is a modification of the above-described first embodiment. The third embodiment is different from the first embodiment in that a mechanism is added that varies the magnification of the optical finder as the magnification of the taking lens system disposed in the lens barrel 2 varies. The third embodiment will be described with regard mainly to this difference.

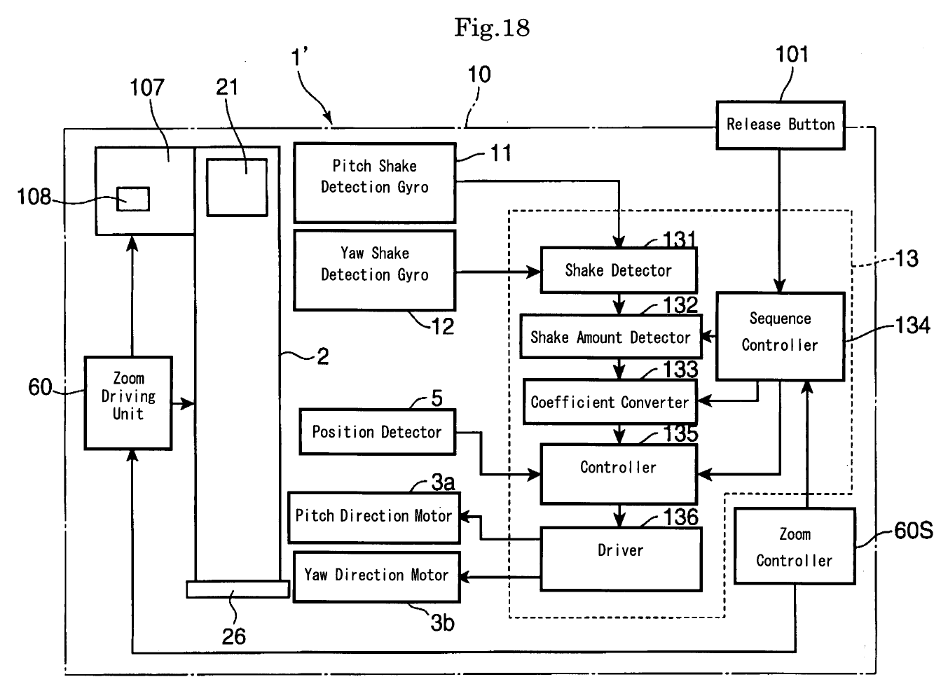

FIG. 18 is a block diagram showing the electrical structure of a lens barrel incorporating camera 1′ according to the third embodiment. In FIG. 18, the parts denoted by the same reference numerals as those of FIG. 4 described previously are the same parts, and descriptions of these parts are omitted. As described previously, the lens barrel incorporating camera 1′ is provided with: the release button 101; the pitch shake detection gyro 11 and the yaw shake detection gyro 12; the circuit arrangement 13; the lens barrel 2 to which the finder block 107 is integrally fixed; the pitch-direction motor 3a and the yaw-direction motor 3b as actuators that drive the lens barrel 2 (and the finder block 107) for shake prevention; and the position detector 5. Further, the lens barrel incorporating camera 1′ is provided with: a zoom driving unit 60 that causes zooming of both of the taking lens system disposed in the lens barrel 2 and the optical system in the finder block 107 to be executed; and a zoom controller 60S that controls the driving of the zoom driving unit 60.

The zoom driving unit 60 is provided with a motor serving as a driving source, a cam mechanism and the like (described later), and the lenses are driven so that the distance between the first zoom lens block 22 and the second zoom lens block 24 disposed in the lens barrel 2 (see FIG. 3) and the distance between the first optical lens 1081 and the second optical lens 1082 disposed in the finder block 107 are displaced in conjunction with each other. By this, the magnification of the lens system of the optical finder varies as the magnification of the taking lens system varies.

The zoom controller 60S generates a focusing control signal for performing zooming, in accordance with a predetermined focusing evaluation value obtained at the time of shooting, and the zoom controller 60S performs the driving control of the zoom driving unit 60 based on the focusing control signal. When the focal length varies, the movement amount for the shake compensation of the lens barrel 2 also varies with respect to the detected shake amount; therefore, the zoom controller 60S transmits focusing information to the sequence controller 134. The focus information is reflected when the calculation to obtain the driving signals (drvx, drvy) in the directions is performed by the controller 135.

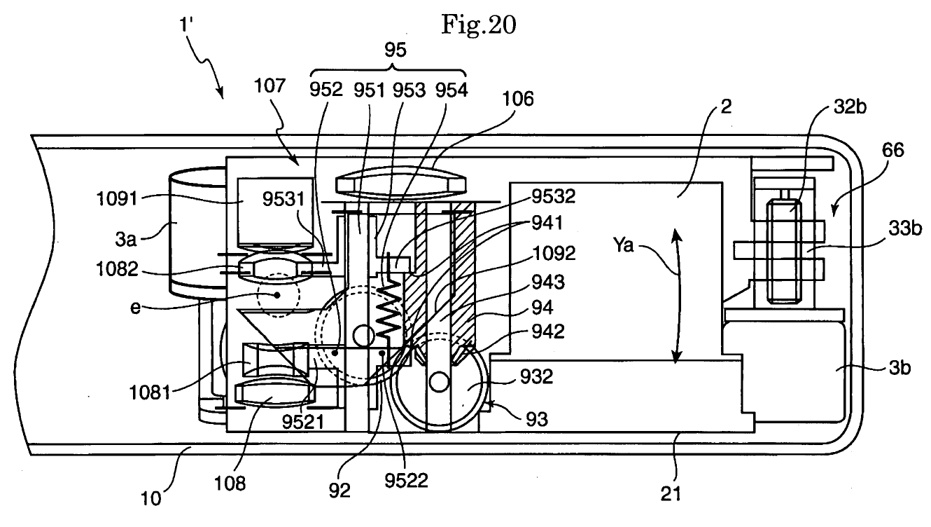

FIG. 19 is a partially cutaway cross-sectional view showing a relevant part of the lens barrel incorporating camera 1′ according to the third embodiment and corresponds to FIG. 6 of the previously described first embodiment. FIG. 20 is a top view on the arrow D3 of FIG. 19 and corresponds to FIG. 9. A side view on the arrow D1 of FIG. 19 which is substantially the same as FIG. 7 and a side view on the arrow D2 of FIG. 19 which is substantially the same of FIG. 8 are omitted. In FIGS. 19 and 20, the parts denoted by the same reference numerals as those of FIGS. 6 and 9 are the same parts, and descriptions of these parts are omitted.

In FIGS. 19 and 20, the zoom driving unit 60 according to the third embodiment is provided with: a zoom actuator 61; a speed change gear unit 610; a lens barrel zoom driving cam 92; an intermediate transmission gear 93; a finder zoom driving cam 94; and a finder lens driving mechanism 95.

The zoom actuator 61 comprises, for example, a stepping motor, and serves as the driving source when zoom driving is performed in the lens barrel 2 and in the finder block 107. The speed change gear unit 610 is a so-called stepped gear in which a plurality of gear pieces 612 are attached to a predetermined driving shaft 611 and the gear pieces 612 mesh with each other in steps. The speed change gear unit 610 converts the rotation force supplied from the stepping motor constituting the zoom actuator 61, into a predetermined speed change ratio, and transmits it to the lens barrel zoom driving cam 92.

The lens barrel zoom driving cam 92 comprises an elongated tubular member rotatably attached around a vertically placed rotation support shaft 91, and is provided with an abutment portion 921, a lower gear portion 922 and an upper gear portion 923. The abutment portion 921 has a predetermined spiral cam step pattern, and normally abuts on a bearing pin 222 provided on a lens holder 221 of the first zoom lens block 22 of the lens barrel 2. By this, the propulsive force caused by the normal-direction rotation of the lens barrel zoom driving cam 92 is transmitted to the lens holder 221 because of the interference between the abutment portion 921 and the bearing pin 222. The lower gear portion 922 meshes with a transmission gear portion 613 (output gear portion) provided on the uppermost gear portion 612 of the speed change gear unit 610. By the lower gear portion 922, the rotation force of the zoom actuator 61 after a speed change is transmitted to the lens barrel zoom driving cam 92.

The lens holder 221 freely slides on a movement shaft 223 provided in a standing condition along the lens barrel 2. During the driving to the telephoto side (zooming), the lens holder 221 receives the propulsive force from the lens barrel zoom driving cam 92 to be moved in the upward direction of FIG. 19 along the movement shaft 223. The lens holder 221 is latched by a compression coil spring 224, and during the driving to the telephoto side, the lens holder 221 is promoted upward against the spring force of the compression coil spring 224. On the other hand, when the driving for return from the telephoto side to the wide-angle side is performed, the lens barrel zoom driving cam 92 is rotated in the opposite direction. Then, the lens holder 221 is moved in the downward direction of the figure along the movement shaft 223 while being pressed by the spiral cam step pattern of the abutment portion 921 by the return spring force of the compression coil spring 224. While the lens holder of the second zoom lens block 24 of the lens barrel 2 is similarly driven by the lens barrel zoom driving cam 92, this part is not shown for the sake of simplifying the figure.

The upper gear portion 923 is provided at the upper end of the lens barrel zoom driving cam 92, and the rotation force of the lens barrel zoom driving cam 92 is transmitted from the upper gear portion 923 to the finder zoom driving cam 94 through the intermediate transmission gear 93. That is, the intermediate transmission gear 93 is provided with a spur gear portion 931 and a bevel gear portion 932, and the lens barrel zoom driving cam 92 is also provided with a bevel gear portion 942. The upper gear portion 923 of the lens barrel zoom driving cam 92 and the spur gear portion 931 of the intermediate transmission gear 93 mesh with each other. Moreover, the bevel gear portion 932 of the intermediate transmission gear 93 and the bevel gear portion 942 of the finder zoom driving cam 94 mesh with each other. By this, the finder zoom driving cam 94 rotates as the lens barrel zoom driving cam 92 rotates.

The finder zoom driving cam 94 comprises a short tubular member rotatably attached around the shaft of a rotation support shaft 943 provided so as to hang across the camera body 10 in the direction of the thickness, and is provided with an abutment portion 941 and the bevel gear portion 942. The abutment portion 941 has a predetermined spiral cam step pattern.

The finder lens driving mechanism 95 is provided with: a movement shaft 951 disposed parallel to the finder zoom driving cam 94; a first lens holder 952 holding the first optical lens 1081 in the finder block 107; a second lens holder 953 holding the second optical lens 1082; and a compression coil spring 954 provided so as to hang between the first lens holder 952 and the second lens holder 953.

The first lens holder 952 and the second lens holder 953 are respectively provided with lens holding flange portions 9521 and 9531 and engagement portions 9522 and 9532 provided on the opposite side in a protruding condition. The first lens holder 952 and the second lens holder 953 are fitted on the movement shaft 951 so that the abutment portion 941 is sandwiched between the engagement portions 9522 and 9532. The engagement portions 9522 and 9532 are pushed toward each other by the compression coil spring 954. By this, the first lens holder 952 and the second lens holder 953 slide on the movement shaft 951 in accordance with the pattern of the abutment portion 941 having the predetermined spiral cam step pattern.

In the above-described structure, when the finder zoom driving cam 94 rotates, the propulsive force caused thereby is transmitted to the first lens holder 952 and the second lens holder 953 by the interference between the abutment portion 941 and the engagement portions 9522 and 9532. Then, the distance between the first optical lens 1081 and the second optical lens 1082 held by the lens holding flange portions 9521 and 9531, respectively, is varied in accordance with the spiral cam step pattern of the abutment portion 941. By this, zooming of the finder optical system is realized.

That is, the subject light image incident on the objective lens 108 of the finder block 107 passes through the first optical lens 1081 and the second optical lens 1082, is reflected upward by the first prism 1091, is incident on the second prism 1092, and then, reaches the eyepiece lens 106. By the distance between the first optical lens 1081 and the second optical lens 1082 being varied, a subject light image corresponding to a telephoto or a wide-angle condition as required can be directed to the eyepiece lens 106. Further, the rotation of the finder zoom driving cam 94 interlocks with the rotation of the lens barrel zoom driving cam 92 that drives the taking lens system (the first and second zoom lens blocks 22 and 24) in the lens barrel 2. Thus, by appropriately selecting, for example, the spiral cam step pattern of the abutment portion 941 or the gear ratio of the spur gear portion 931 of the intermediate transmission gear 93, the magnification of the finder optical system can be varied in response to the zooming of the taking lens system.

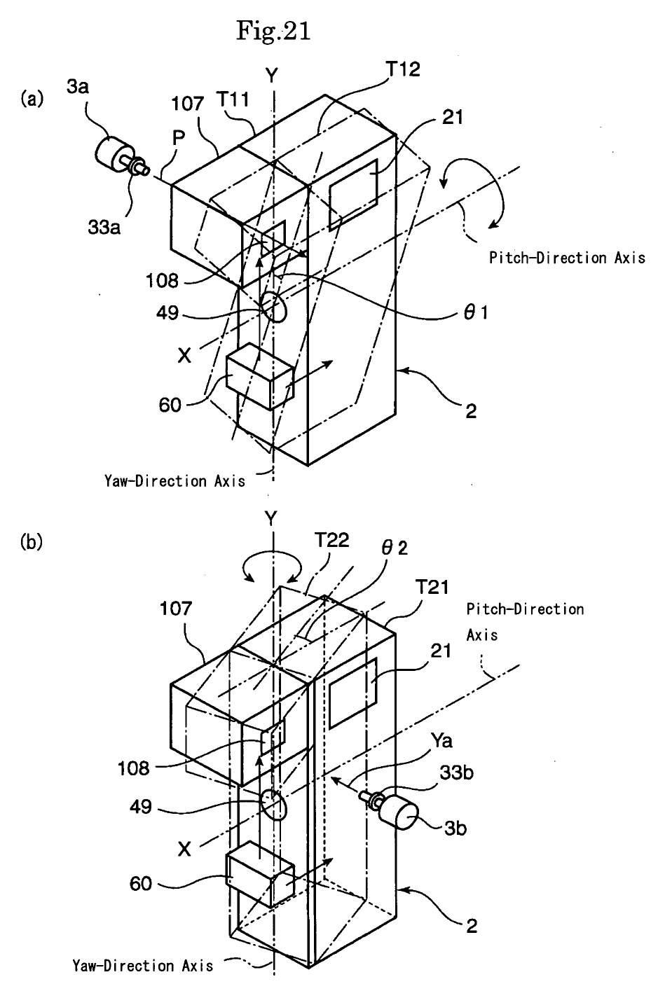

FIGS. 21(a) and 21(b) are views schematically showing the movement condition of the lens barrel 2 according to the third embodiment. In the third embodiment, the swinging operation itself of the lens barrel 2 itself by the pitch-direction motor 3a and the yaw-direction motor 3b is similar to the operation described with reference to FIG. 11 in the first embodiment. In FIGS. 21(a) and 21(b), the finder block 107 fixed to the lens barrel 2 is also illustrated. As shown in FIG. 21(a), when the lens barrel 2 is rotated by a predetermined angle θ1 in the rotation direction of the pitch-direction shaft from the position shown by the solid line T11 in the figure to the position shown by the chain line T12 in the figure by the pitch-direction motor 3a, the finder block 107 is rotated in the direction of the arrow P in response thereto. Moreover, as shown in FIG. 21(b), when the lens barrel 2 is rotated by a predetermined angle θ2 in the rotation direction of the yaw-direction shaft from the position shown by the solid line T21 in the figure to the position shown by the chain line T22 in the figure by the yaw-direction motor 3b, the finder block 107 is rotated in the direction of the arrow Ya in response thereto.

That is, not only the lens barrel 2 but also the finder block 107 is driven for shake prevention in synchronism by the pitch-direction motor 3a and the yaw-direction motor 3b. For this reason, it is unnecessary to separately provide a mechanism for driving the finder optical system for shake prevention, and the user can directly notice the shake prevention driving effect through the finder. Further, since the objective lens 108 of the finder block 107 is disposed in the vicinity of the objective lens 21 of the lens barrel 2, when the shake prevention driving is provided with the lens barrel 2 as the target, a shaking force close to the shake of the lens barrel 2 is also supplied to the finder block 107, so that the shake compensation accuracy of the finder block 107 can be improved.

Further, by the zoom driving unit 60 integrally provided in the lens barrel 2, the variation in the magnification of the taking lens system in the lens barrel 2 and the variation in the magnification of the optical system in the finder block 107 interlock with each other. That is, since the magnification of the optical finder varies in response to the movement of the zooming of the taking lens system in the lens barrel 2, a light image corresponding to the zoom condition of the taking lens system can be provided to the user through the finder. As a concrete structure that performs zooming, the lens barrel zoom driving cam 92 is rotated by the zoom actuator 61, and the lens barrel zoom driving cam 92 and the finder zoom driving cam 94 are coupled together by the intermediate transmission gear 93. That is, since the lens barrel zoom driving cam 92 and the finder zoom driving cam 94 are driven by the same driving source, the zoom actuator 61, it is unnecessary to separately provide a driving source although the optical finder is provided with a structure for performing zooming, so that size reduction and cost reduction can be achieved.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

1. A camera incorporating a lens barrel comprising:
a lens barrel having a taking lens system and incorporated in a camera body;
a supporter for supporting the lens barrel so as to be swingable;
a shake detector for detecting a shake applied to the camera;
a calculator for calculating a correction movement amount for moving the lens barrel based on a detection signal from the shake detector; and
an actuator for moving the lens barrel in accordance with the correction movement amount obtained by the calculator.

2. The camera according to claim 1, wherein the lens barrel is a bent-type lens barrel, and is vertically placed inside the camera body.

3. The camera according to claim 1, wherein a support point of the supporter is set in the vicinity of the center, in the direction of the length, of the lens barrel.

4. The camera according to claim 1, wherein the supporter supports the lens barrel so as to be swingable in a yaw direction and in a pitch direction.

5. The camera according to claim 4, wherein the actuator comprises a yaw-direction motor which moves the lens barrel in the yaw direction and a pitch-direction motor which moves the lens barrel in the pitch direction.

6. The camera according to claim 1, wherein the actuator is a stepping motor.

7. The camera according to claim 1, wherein a support point of the supporter comprises a pivot bearing.

8. The camera according to claim 7, wherein the actuator comprises a yaw-direction motor and a pitch-direction motor, and wherein the yaw-direction motor is disposed in a rotation direction of a yaw-direction axis of the support point, and the pitch-direction motor is disposed in a rotation direction of a pitch-direction axis of the support point.

9. The camera according to claim 8, wherein a distance between the position of the yaw-direction motor and the support point and a distance between the position of the pitch-direction motor and the support point are substantially the same.

10. The camera according to claim 7, wherein the lens barrel comprises a restricting shaft extending from the support point substantially in a radial direction, and the restricting shaft is engaged with an elongate hole provided on the supporter for guiding the movement of the lens barrel.

11. The camera according to claim 1, wherein a support point of the supporter comprises a bearing that supports the lens barrel so as to be rotatable in a two axial directions in which the lens barrel is to be moved.

12. The camera according to claim 1, further comprises a solid-state image sensor fixed to the lens barrel.

13. The camera according to claim 1, further comprises an optical finder fixed on the lens barrel.

14. The camera according to claim 13, wherein the optical finder moves in response to the movement of the lens barrel by the actuator.

15. The camera according to claim 13, wherein the taking lens system and the optical finder have a zooming mechanism, respectively, and a magnification of the optical finder changes in response to a zooming of the taking lens system.

16. The camera according to claim 13, wherein the optical finder comprises an objective lens disposed in the vicinity of an objective lens of the taking lens system.

17. A camera incorporating a lens barrel comprising:
a lens barrel having a taking lens system and incorporated in a camera body;
a support plate fixed to the camera body and having a support point that supports the lens barrel so as to be swingable at least in two axial directions;
a shake detector for detecting a shake applied to a camera;
a calculator for calculating a correction movement amount for moving the lens barrel based on a detection signal from the shake detector;
a first actuator for moving the lens barrel in a first axis direction in accordance with the correction movement amount obtained by the calculator; and
a second actuator for moving the lens barrel in a second axis direction in accordance with the correction movement amount obtained by the calculator,
wherein the first actuator and the second actuator are each attached to the support plate,
wherein the first actuator and the second actuator both have a point of action of a movement to the lens barrel, and
wherein the first actuator and the second actuator both move the lens barrel in the first axis direction and in the second axis direction, respectively, with the support point at the support plate as an axis.

18. The camera according to claim 17, wherein the first actuator is a yaw-direction motor which moves the lens barrel in the yaw direction and the second actuator is a yaw-direction motor that moves the lens barrel in the pitch direction.

19. The camera according to claim 18, further comprises a movement piece which is movable in the direction of the rotation axis in accordance with the rotation of the motor, on each of rotation axes of the yaw-direction motor and the pitch-direction motor, and wherein the point of action of the movement is a part where the movement piece and an engagement part provided on the lens barrel interfere with each other.

20. The camera according to claim 19, further comprises a ball bearing constituting a pivot bearing is interposed between the support plate and the lens barrel, and wherein the lens barrel rotates in a rotation direction of a yaw-direction axis by the yaw-direction motor and rotates in a rotation direction of a pitch-direction axis by the pitch-direction motor, with the ball bearing as the axis.

21. The camera according to claim 19, wherein the support plate comprises a first support plate fixed directly to the camera body and a second support plate fixed to the first support plate through a first bearing, and wherein the second support plate and the lens barrel are coupled together through a second bearing in a direction orthogonal to a shaft support direction by the first bearing.

22. The camera according to claim 21, wherein one of the yaw-direction motor and the pitch-direction motor is fixed to each of the first support plate and the second support plate, and wherein the lens barrel rotates in the rotation direction of the yaw-direction axis by the yaw-direction motor and rotates in the rotation direction of the pitch-direction axis by the pitch-direction motor, with the first bearing and the second bearing as an axis.

23. The camera according to claim 17, further comprises:
an optical finder which is fixed on the lens barrel and moves in response to the movement of the lens barrel;
a first zooming mechanism for changing a magnification of the optical finder;
a second zooming mechanism for changing a magnification of the taking lens system; and
a driving source for driving the first zooming mechanism and the second zooming mechanism.
